(19) United States
(12) Patent Application Publication
(10) Pub. No.: US 2025/0349117 A1
(43) Pub. Date: Nov. 13, 2025

(54) OPTICAL METASURFACE FOR INTELLIGENT SENSING, IMAGING AND PROCESSING

(71) Applicant: The Chinese University of Hong Kong, Hong Kong (CN)

(72) Inventors: Chaoran HUANG, Hong Kong (CN); Chester SHU, Hong Kong (CN); Mingcheng LUO, Hong Kong (CN)

(21) Appl. No.: 19/202,413

(22) Filed: May 8, 2025

Related U.S. Application Data
(60) Provisional application No. 63/643,973, filed on May 8, 2024.

(51) Int. Cl. G06V 10/82; G06V 10/14; G06V 10/77

(52) U.S. Cl. CPC G06V 10/82; G06V 10/14; G06V 10/7715; G06V 2201/03

(57) ABSTRACT

An optical neural networks (ONNs) system for intelligent sensing, imaging, and processing is provided, including an optical metasurface having arrays of sub-wavelength meta-atoms, each meta-atom being independently configured to modulate amplitude and phase of light beams incident to the optical metasurface for performing complex-valued dot products. Moreover, the ONNs system may further include a focusing lens for receiving and processing the light beams output from the optical metasurface. Each meta-atom is a sub-wavelength-scale periodic pillar that is transmissive and has a cylindrical structure with a diameter configured to finely tune its modulation coefficient. The optical metasurface and the focusing lens are configured to transform a raw optical image to a low-dimensional Fourier feature map. An image sensor array captures the low-dimensional feature map and convert it into a digital feature map of a digital format and a digital processor processes the digital feature map for performing machine vision tasks.

### CROSS-REFERENCE TO RELATED APPLICATION

This application claims the benefit of U.S. Provisional Application Ser. No. 63/643,973, filed May 8, 2024, which is hereby incorporated by reference in its entirety including any tables, figures, or drawings.

### BACKGROUND OF THE INVENTION

Neural networks have become a powerful tool across various scientific and technological domains, triggering transformative shifts in fields such as drug discovery, image processing, autonomous vehicles, and medical diagnostics. However, the increasing complexity of challenges is causing the cost for training and inferring neural network models to double every 3.4 months. This trend outpaces the advancements in complementary metal-oxide-semiconductor (CM OS) circuits, which have traditionally thrived under Moore's Law but are now approaching their physical limits. Concurrently, there is a pressing need to minimize latency in both training and inference processes, driven by the rise of time-sensitive applications such as navigation of self-driving cars, robotics, and real-time analytics for healthcare and surgery. While multi-core and multi-processor architectures offer a solution to address the limitations of single-processors, the growing demand for data movement is creating interconnect bottlenecks that adversely impact both computing time and energy consumption.

To tackle these challenges, the new computing paradigm-neuromorphic computing, has gained traction. In neuromorphic computing systems, neural network weights are stored in a non-volatile manner and co-located with the computational elements. This innovation alleviates the data movement bottleneck, resulting in substantial improvement in computing speed and energy efficiency. Optical neural networks (ONNs) hold great promise for realizing neuromorphic computing thanks to the high degree of parallelism inherent in light waves. Recent notable work includes free-space-based diffractive neural networks, optical convolutional neural networks, and optical encoders. Harnessing this parallelism, ONNs can execute linear operations, such as matrix multiplications, in a single shot. Consequently, for tasks like matrix multiplications, characterized by computational complexity scaling as O(N²), both computational time and the energy costs can be reduced to O(N), with the majority cost devoted to generating input optical signals. In more favorable scenarios, such as when input signal is already in the optical domain (for example, Lidar, microscopy, optical communication systems), the computational time and energy costs can be further reduced to O(1). Therefore, ONNs offer notable advantages in energy efficiency and speed, especially when handling a large number of weights and sizable inputs.

Despite the theoretical potential of ONNs, their current implementations face challenges related to weight count and input size. Two-dimensional (2D) integrated ONNs offer high computing speeds but are limited by large footprint of optical components and control issues, restricting them to a few thousand components. On the other hand, three-dimensional (3D) free-space ONNs exhibit good promise in scalability by harnessing parallel spatial modes. Experimental demonstrations have successfully realized approximately 10⁵ scalar multiplications. However, the achieved weight number still falls short when compared to neural networks realized on digital CMOS circuits, which supports weight numbers ranging from tens of millions to hundreds of billions. Moreover, even in the best ONN demonstrations, input signal dimensions are limited to a few thousand pixels, whereas real-world applications, such as medical images, often entail significantly larger input sizes. Additionally, many 3D ONNs rely on bulky optical equipment, such as spatial light modulators for weight implementation, hindering integration with edge devices. These limitations have confined the applications of most ONNs to only demonstrating basic benchmarks rather than addressing real-world challenges.

### BRIEF SUMMARY OF THE INVENTION

There continues to be a need in the art for improved designs and techniques for optical metasurface for intelligent sensing, imaging, and processing.

According to an embodiment of the subject invention, an optical neural networks (ONNs) system comprises an optical metasurface comprising a plurality of arrays of sub-wavelength meta-atoms, wherein each meta-atom is independently configured to modulate both amplitude and phase of light beams incident to the optical metasurface for performing complex-valued dot products. The ONNs system may further comprise a focusing lens for receiving and processing the light beams output from the optical metasurface. Each meta-atom of the plurality of arrays of sub-wavelength meta-atoms is a sub-wavelength-scale periodic pillar disposed on a two-dimensional plane. The periodic pillar is made of silicon and has a cylindrical structure. The periodic pillar has a diameter configured to finely tune its modulation coefficient. Moreover, each meta-atom of the plurality of arrays of sub-wavelength meta-atoms is configured to act as an optical node for individually modulating the transmissive or reflective phase and amplitude of the input light beams. Coefficients of the phase and amplitude modulation of each optical node are randomly selected. The optical metasurface is configured to transform a raw optical image to a low-dimensional feature map. The raw optical image is element-wise modulated by the optical metasurface and then spatial components of the modulated optical image are linearly summed by spatial Fourier transformation performed by the focusing lens to generate the low-dimensional feature map. In addition, the raw optical image is element-wise modulated by the optical metasurface and then spatial components of the modulated optical image are weighted and linearly summed by spatial Fourier transformation performed by an optical focusing lens or other types of optical devices. The performing complex-valued dot products is conducted by the optical metasurface with millions to billions of weights. Furthermore, geometry distribution of the plurality of arrays of sub-wavelength meta-atoms is configured such that corresponding matrix are ensured to attain an optimized Gaussian distribution.

### BRIEF DESCRIPTION OF THE DRAWINGS

FIGS. 1A-1E show the metasurface-based optical neural network (meta-ONN), wherein FIG. 1A shows schematic representation of the meta-ONN, wherein the optical image generated by the SLM is projected onto a single-layer metasurface comprising massive cylindrical silicon nanodisks, an optical lens then collects the reflected optical image by the metasurface, next, the optical field at the focusing plane is captured by an image sensor array, then, the captured image is fed into a digital neural network to produce the prediction result; wherein FIG. 1B shows the model of the meta-ONN; wherein FIG. 1C shows the NTK analysis of the a single-layer meta-ONN with tens of millions of nanodisk (neuron nodes) (upper) and 5-layered phase-mask-based ONN with only a million of neuron nodes (bottom); wherein FIG. 1D shows the eigenvalues of the trained NTKs over the frequency range for various ONNs; wherein FIG. 1E shows the comparison of the accuracies obtained from various ONNs without training the optical layer, according to an embodiment of the subject invention. The results show that the single-layer meta-ONN with tens of millions of nanodisk, without training, outperforms the 5-layered trained ONN.

FIGS. 2A-2M show experimental results of the meta-ONN for three benchmark tasks, wherein FIG. 2A shows a schematic representation of the experimental setup of meta-ONN for the benchmark task; wherein FIG. 2B shows an image of the metasurface chip compared with a Hong Kong dollar coin; wherein FIG. 2C shows an optical microscope image of the fabricated metasurface chip with a compact area of 3.2×3.2 mm² (left graph) and the scanning electron microscope (SEM) image of a zoom-in metasurface region containing 25×25 nanodisks (right graph); wherein FIG. 2D shows the measurement results of quantitative phase imaging (QPI) of a zoom-in region of the metasurface chip, wherein in the color wheel, the color represents the phase modulation coefficient, and the brightness represents the amplitude modulation coefficient; wherein FIG. 2E shows illustration of the dataset images of the COVID-19 Radiography, wherein FIG. 2F shows illustration of the dataset images of the NIH ChestX-ray8, and wherein FIG. 2G shows illustration of the dataset images of the RSNA Intracranial Hemorrhage Detection tasks; wherein FIG. 2H shows the accuracy versus optical neuron number of the meta-ONN for the COVID-19 Radiography, wherein the dashed line represents the accuracy of SAM as a comparison; the inset graphs with colorful scatters represent the results of the t-SNE analysis; wherein FIG. 2I shows the confusion matrix of the prediction result of the NIH ChestX-ray8, wherein FIG. 2J shows bleeding regions inside the brain predicted by the meta-ONN (bottom graph) and digital ResNet-50 (upper graph); wherein FIGS. 2K-2M show comparison of accuracy and electronic parameters of the meta-ONN with other optical approaches, in particular, FIG. 2K shows the digital models for the COVID-19 Radiography, FIG. 2L shows the NIH ChestX-ray8, and FIG. 2M shows the RSNA Intracranial Hemorrhage Detection tasks, according to an embodiment of the subject invention.

FIGS. 3A-3F show experimental results of the meta-RNN for video-based human action recognition, wherein FIG. 3A shows the working flow of the metaRNN for video-based human action recognition, the action video is processed by the meta-RNN in a frame-by-frame way, each action video contains 20 frames with a time interval of 80 ms, firstly, the input frame xt with 120×160 pixels is encoded into the optical domain without any preprocessing, it is then processed by the meta-ONN to generate a compressed digital image f (xt) with 34×45 pixels, the processed frame is fused with the output at the previous frame to form the output at the current frame, that is, ht=ht−1+f(xt), finally, the output at the current frame is fed into a digital neural network to produce a frame-wise prediction result yt, the action prediction result is the label that appears most frequently in all frame-wise results of the action video; wherein FIG. 3B shows the confusion matrix of frame-wise prediction results; wherein FIG. 3C shows the confusion matrix of action prediction results; wherein FIG. 3D shows performance comparison of the meta-ONN with the existing digital and optical approaches, wherein the training time and processing speed of the meta-RNN are the predicted ones based on current experimental results, wherein FIG. 3E shows the ability of the meta-RNN in quickly recovering the accuracy after experiencing a hard perturbation, and wherein FIG. 3F shows the action accuracy versus averaged photons per complex-valued multiplication, according to an embodiment of the subject invention.

FIGS. 4A-4D show experimental results of the meta-ONN for cancer diagnosis based on the whole slide image, wherein FIG. 4A shows the working flow of the cancer diagnosis based on the whole slide image, the input WSI with over 2.2×1010 pixels is preprocessed with the Ostu method and cropped into a series of patch images with 1,000×1,000 pixels, the patch images are processed by the meta-ONN in a single shot and compressed into 30×40 pixels, finally, these processed images are fed to a highly compact digital neural network to generate the final prediction result of whether the tumor cell is detected in the image, wherein FIG. 4B shows the ROC curve of the patch-level prediction results during the training phase; wherein FIG. 4C shows the heat map of the prediction probabilities of the meta-ONN and the existing segmentation model (SAM); wherein the inset graphs a, b, and c represent three different zoom-in regions of the WSI, respectively; wherein FIG. 4D shows comparison of the training time and inference time of the meta-ONN with SAM, the time consumption of the meta-ONN is the predicted one based on current experimental results, according to an embodiment of the subject invention.

### DETAILED DISCLOSURE OF THE INVENTION

Embodiments of the subject invention pertain to an optical neural network (ONN) system based on an optical metasurface comprising tens of millions to billions of meta-atoms, whose transmission follows a Gaussian distribution.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

The term “highly compact neural network” denotes a digital neural network at the digital backend, characterized by a relatively small number of parameters ranging from tens to a few thousand.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Herein, a three-dimensional (3D) ONN built upon an optical metasurface is provided, showing its ability to handle diverse real-world machine learning tasks with exceptional scalability and performance. The optical metasurface is a type of remarkable and extremely compact free-space optic devices, comprising vast arrays of sub-wavelength meta-atoms arranged in an intricately arranged pattern on a two-dimensional plane. Each meta-atom can be independently designed to modulate both the amplitude and phase of input light beams, effectively performing complex-valued dot products. Leveraging advanced fabrication technology, meta-atoms can achieve densities exceeding 10¹⁰ per cm², comparable to the transistor density in cutting-edge CMOS processors. Consequently, these precisely designed meta-atoms offer unparalleled parallelism, allowing for the execution of complex-valued matrix multiplications with over a billion weights within a compact metasurface chip having an area of, for example, 1 cm², all in a single shot and with nearly-zero energy consumption.

However, notwithstanding its theoretical advantages, this approach is subject to challenges analogous to those observed in other three-dimensional optical neural networks (3D ONNs), primarily arising from the complexities associated with the precise fabrication and implementation of large-scale meta-atom arrays. Consequently, both the scalability and overall performance of the system are substantially constrained. Furthermore, the existing techniques lack the capability to actively tune metasurfaces at scale, thereby rendering metasurface-based ONNs predominantly limited to single-task operations. In contrast to prior work, a large-scale and versatile ONN is experimentally demonstrated, integrating over 41 million meta-atoms within a single metasurface chip. This architecture represents the largest neuron capacity ever shown in an experimental setting. Both theoretical analysis and empirical results confirm that only when the neuron count reaches this scale, the metasurface-based ONN (meta-ONN) of the subject invention exhibit behavior analogous to that of an infinitely wide NN, thereby achieving performance levels comparable to large NN models such as Residual Neural Network (ResNet) and Vision Transformer.

Furthermore, it has been observed that when initializing the weights with a Gaussian distribution, even in the absence of any training process, the meta-ONN can achieve comparable and satisfactory performance on par with those of trained networks. The unique performance stems from a new computing framework based on random projection. Unlike conventional ONNs, that are optimized for a specific task, random projection operates as a universal kernel machine, offering broad generalizability across a wide range of tasks.

Assisted by a highly compact and programmable electronic NN at the backend, the non-reconfigurability in metasurfaces is overcome, making the overall system trainable, versatile and achieve best-in-class performance across different tasks. Furthermore, the random projection requires only that the transmission matrix follows a Gaussian distribution, eliminating the necessity for precise design of each individual meta-atom. This flexibility enables the system to scale without being constrained by fabrication or implementation errors, allowing the meta-ONN to expand to arbitrary widths, depths, and high level of complexity of neural network models.

To demonstrate the generality of the approach of the subject invention, a range of applications, including image classification and detection, are showcased. Using a single metasurface layer and a compact digital model with fewer than 10,000 parameters, the system of the subject invention achieves performance far surpassing that of the existing ONNs and rivaling deep, large-scale AI models such as Vision Transformer. To illustrate the exceptional scalability of the approach of the subject invention, high-resolution medical images with over a million pixels are processed.

Additionally, a recurrent neural network (RNN) with optical metasurfaces is implemented for human action recognition, achieving an impressive accuracy of 99.1%. This highlights the system's ability to scale to deep layers without being constrained by physical fabrication errors. Leveraging the remarkable advantages, it is further demonstrated that the system of the subject invention addresses real-world challenges beyond the reach of the existing ONNs to accelerate the analysis of multi-gigapixel whole slide images (WSIs) for cancer detection by processing million-pixel sub-images in a single shot.

By conducting over 99.995% of computations in the optical domain with a passive metasurface chip, the system of the subject invention can achieve an energy efficiency over 240 TOPS/W. This figure includes the power consumption of peripheral circuits for optical signal generation and detection. The meta-ONN of the subject invention not only surpasses digital electronics in speed and energy efficiency, but also matches the performance of the existing large AI models in accuracy and versatility, thereby offering a novel and highly scalable pathway for enabling large-scale AI computing with optical systems.

According to the embodiments of the subject invention, by exploring extensive parallelism exclusively within the optical metasurfaces, a best-in-class ONN has been experimentally demonstrated to be capable of: (1) handling sizable inputs with a resolution exceeding a million pixels, (2) achieving superior performance across diverse machine learning tasks, rivaling dense and deep neural network models such as ResNet and Vision Transformer, while with training times accelerated by up to 5 orders of magnitude and energy consumption reduced by a factor of 10⁵ on average; and (3) addressing the real-world challenges previously unattainable by the existing ONNs, such as analyzing multi-gigapixel whole slide images for cancer diagnosis. Furthermore, through both experimentation and simulation, it has been demonstrated that the exceptional performance of the meta-ONN can be attributed to the utilization of a large number of weights ranging from millions to billions, in parallel—the largest weight capacity ever demonstrated in experiments. This capacity translates to an experimental computing throughput exceeding 10⁵ tera operations per second (TOPS) calculated by a chip having an area of 10 mm², with an energy efficiency of 0.2 femtojoules per operation (fj/OP).

Herein, the metasurface refers to a free-space-based optical component comprising a significant number of sub-wavelength-scale periodic pillars arranged in a two-dimensional plane, where every pillar acts as an optical node, capable of individually modulating the transmissive or reflective phase and amplitude of the incident light. Unlike the conventional optical machine vision devices, which are generally implemented by the co-optimization of optical and digital systems, the system of the subject invention eliminates the need for additional cost of optimizing or training the metasurface. In this approach, the phase and amplitude modulation coefficients of each optical node are randomly selected. It is noteworthy that the metasurface can accommodate an extensive number of optical nodes, exceeding 10 million in scale, owing to the sub-wavelength dimensions of the pillars.

In one embodiment, for example, 40 million nodes are realized within a single metasurface with an area of just 10 mm². Such large-scale complex-valued optical nodes ensures the requisite complexity for transforming the incident optical field, thereby guaranteeing high performance in machine vision tasks such as high accuracy in object classification.

The transformation from the raw optical images to low-dimensional feature maps is realized by two key processes. Initially, the raw optical images are element-wise modulated by the optical nodes of the metasurface. Subsequently, the spatial components of the modulated optical images are weighted and linearly summed. This weighting and linearly summing of the spatial components are implemented by spatial Fourier transformation of the optical images using an optical focusing lens. Notably, the two processes are achieved in the optical domain, offering a sub-picosecond latency and nearly zero power consumption.

The machine vision tasks using the feature maps are performed by following two processes. In the first process, the generated feature maps are captured by an image sensor array and converted into a digital format. In the second process, digital algorithms are employed to process the digital feature maps, enabling performing of various machine vision tasks.

In one embodiment, the fabricated metasurface comprises cylindrical pillars, with diameters adjusted to finely tune the modulation coefficient of every optical node. Alternatively, the metasurface can also include cubical pillars, which provide a configurable phase modulation up to 2π for the incident light by rotating the in-plane angle of the cuboid. The raw pathology images are encoded into the optical domain using a laser source having a frequency of, for example, 532 nm, in conjunction with spatial light modulators. The light-encoded pathology images are then transmitted/reflected by the metasurface, and subsequently being focused by an optical lens. The resulting optical images at the focal plane are captured by a camera with a pixel scale of, for example, 800×600. These captured images are further down-sampled into digital images with pixel scales ranging from a few hundreds to a few thousands, depending on the tasks. At the digital backend, a highly compact neural network is trained to generate the final decision.

### Comparison with Existing Technology

For the existing optical AI accelerators, two-dimensional (2D) integrated optical neural networks offer high computing speed. However, they are limited by large footprint of optical components and control challenges, restricting them to a few thousand components (i.e., weights).

Meanwhile, there are proposals for utilizing 3D optical neural network. Y et, the major constrains are their scalability, stemming from various factors, including the number of controllable pixels, challenges associated with training on large-scale, complex physical models, and the necessity for precise hardware implementation requiring sub-wavelength level accuracy. Furthermore, many 3D ONNs rely on bulky optical equipment, such as spatial light modulators, impeding integration with edge devices. These limitations have restricted the applications of most ONNs to merely demonstrating rudimentary benchmarks rather than effectively addressing real-world challenges.

According to the embodiments of the subject invention, the features of the optical part of the machine vision system are listed as follows: (1) using a single metasurface rather than multi-layered devices to manipulate the light, mitigating the issue of alignment in the system; (2) the compact metasurface can be integrated with the rear-end digital systems, enabling high-level integration and miniaturization of the system; and (3) the geometric pattern of the metasurface is randomly created, inhibiting the performance degradation arising from the design errors.

With these advantages, the best-in-class ONN is experimentally demonstrated to be capable of: (1) handling sizable inputs at the resolution exceeding a million (1024×1024); (2) achieving superior performance even compared to software-based NN models across diverse machine learning tasks, all with performance comparable with very deep neural network models; and (3) addressing real-world challenges, such as the detection and location of breast cancer that has spread (metastasized) to lymph nodes adjacent to the breast, that have never been realized by the existing ONNs.

Furthermore, it is demonstrated by both experimentation and simulations that the exceptional performance of the meta-ONN according to the embodiments of the subject invention can be attributed to the utilization of a large number of weights ranging from millions to billions, which is the most extensive weight capacity ever demonstrated, achieving an experimental throughput exceeding 10⁵ TOPS with almost zero power consumption.

### Advantages of Subject Invention

The embodiments of the subject invention are exceptionally well-suited for AI inference applications for both data centers and edge devices. Currently, major cloud providers including AWS, Google Cloud, and Microsoft Azure rely heavily on Nvidia GPUs to bolster AI services for their clientele. However, there exists a crucial gap to minimize latency in both the training and inference phases. This urgency is fueled by the emergence of time-sensitive applications such as the navigation of self-driving cars, robotics, and real-time analytics for healthcare and surgery. However, with increasing the size of AI models, the GPUs encounter challenges concerning both costs and power consumption.

The solution according to the embodiments of the subject invention effectively addresses these limitations. The optical AI metasurface chips offer an excellent balance between performance, costs, and power consumption, holding the potential to substantially alleviate the financial and energy consumption burdens associated with AI applications, making powerful AI capabilities more accessible to a broader customer base and propelling advancements in crucial sectors such as healthcare, automation, and education.

### Results

The experimental results demonstrate exceptional capabilities of the ONN, including but not limited to:
(1) effectively processing large inputs, with a resolution exceeding a million (1024×1024);
(2) outperforming software-based Neural Network (NN) models across diverse machine learning tasks, rivaling even very deep neural network models; and
(3) addressing previously unexplored real-world challenges, exemplified by the successful detection of breast cancer that has spread (metastasized) to lymph nodes adjacent to the breast.

Moreover, results of both experimentation and simulation suggest that the outstanding performance of the meta-ONN of the subject invention is attributed to the unprecedented utilization of tens of million weights, marking the most extensive weight capacity ever demonstrated and achieving an experimental throughput exceeding 10⁵ TOPS with almost zero power consumption.

Packaging and integration may be explored to reduce the volume of the optical front-end system and enhance overall system miniaturization. Additionally, the periphery circuits may be optimized to minimize latency and power consumption by shortening the signaling chain from camera capture to digital algorithm inferences.

Following are examples that illustrate procedures for practicing the invention. These examples should not be construed as limiting. All percentages are by weight and all solvent mixture proportions are by volume unless otherwise noted.

### Example 1—System Description and Working Principle

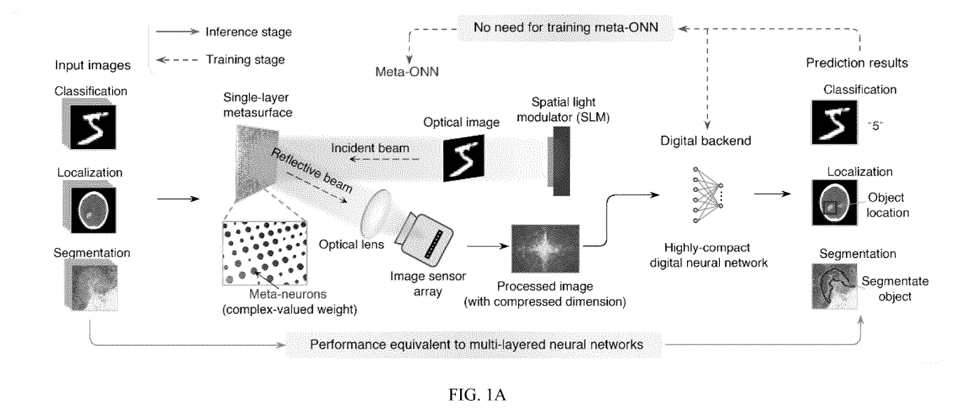

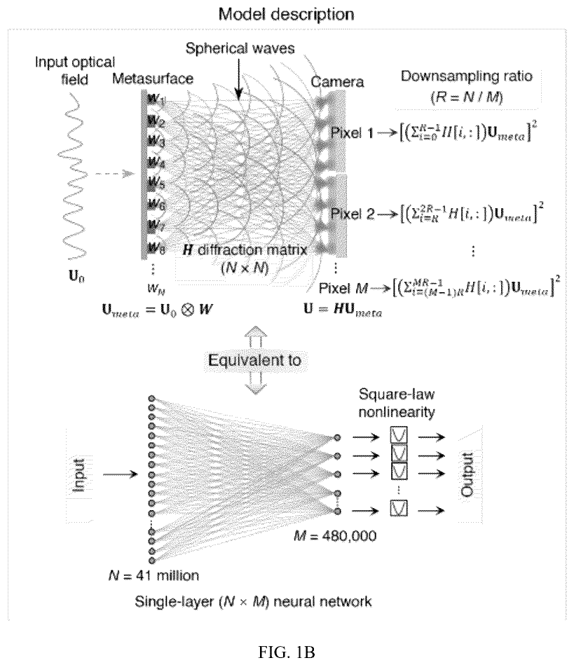

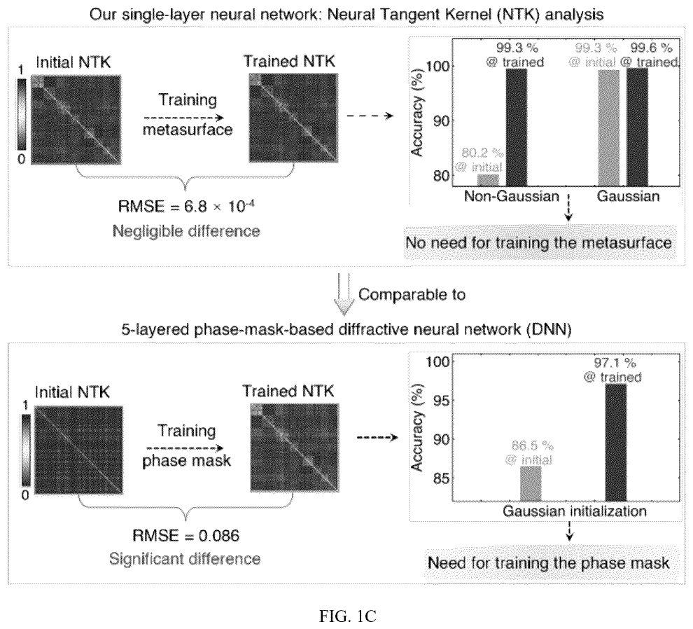

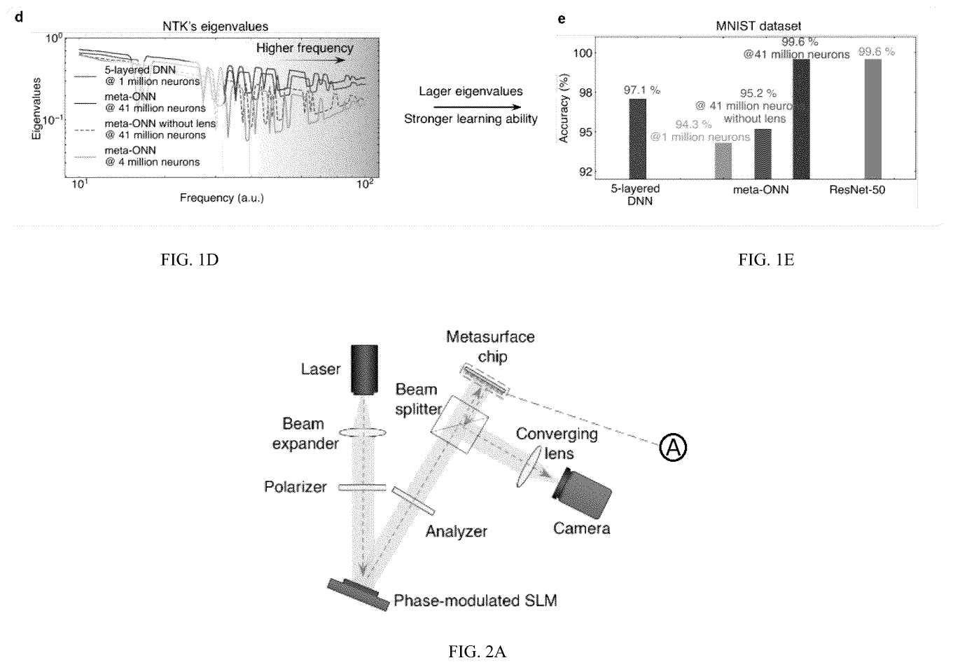

The implementation of the meta-ONN of the subject invention is illustrated in FIG. 1A and the model description of the meta-ONN is illustrated in FIG. 1B. The meta-ONN is a dielectric metasurface comprising 41 million silicon cylindrical pillars in a chip area of 10 mm². Each pillar serves as a neural node, which controls the transmissive and reflective phase and amplitude of the incident light at a subwavelength scale. These modulation values are determined by the interference between electric and magnetic dipole resonances within each nanodisk, which can be adjusted by varying the nanodisk's radius. Alternatively, the cylindrical pillars can be replaced by cubical pillars, which provide a configurable phase modulation up to 2 for the incident light by rotating the in-plane angle of the cuboid. The incident beam, carrying encoded input information such as images, is modulated by the metasurface, resulting in a dense complex-valued matrix multiplication involving all 41 million elements. The values of this matrix are determined by the radius of each pillar. To demonstrate the meta-ONN's capability for large-scale matrix transformations, its complex field transmission is experimentally measured using quantitative phase imaging. The results show a complex field multiplication at subwavelength resolution, as depicted in FIG. 1E. Subsequently, the modulated beam is collected by an optical lens and focused onto an image sensor, where coherent summation occurs. The image sensor introduces an optoelectronic nonlinear activation function through square-law detection. The final decision is made by a highly compact neural network, which can be implemented in either a digital processor or an in-sensor neural network.

The existing 3D ONNs often struggle with the challenge of accurately training a large number of physical parameters. Even slight misalignments at sub-wavelength scales can lead to significant reductions in accuracy and require retraining.

Since the number of pixels in the detector (480,000 pixels in the experiments) is significantly smaller than the number of meta-atoms (41 million), the optical field at the receiver is effectively downsampled through sum pooling, whereby neighboring elements are summed together. This process forms an extremely wide single-layer neural network with 480,000×41 million weights, though the actual degrees of freedom for tuning are limited to the 41 million meta-atoms. An optical lens is placed between the metasurface and the image sensor array to perform a Fourier transform, which, as shown later, enhances the network's ability to extract high-frequency features. The image sensor array then applies a square function to the pooled signal, providing the nonlinearity of the NN.

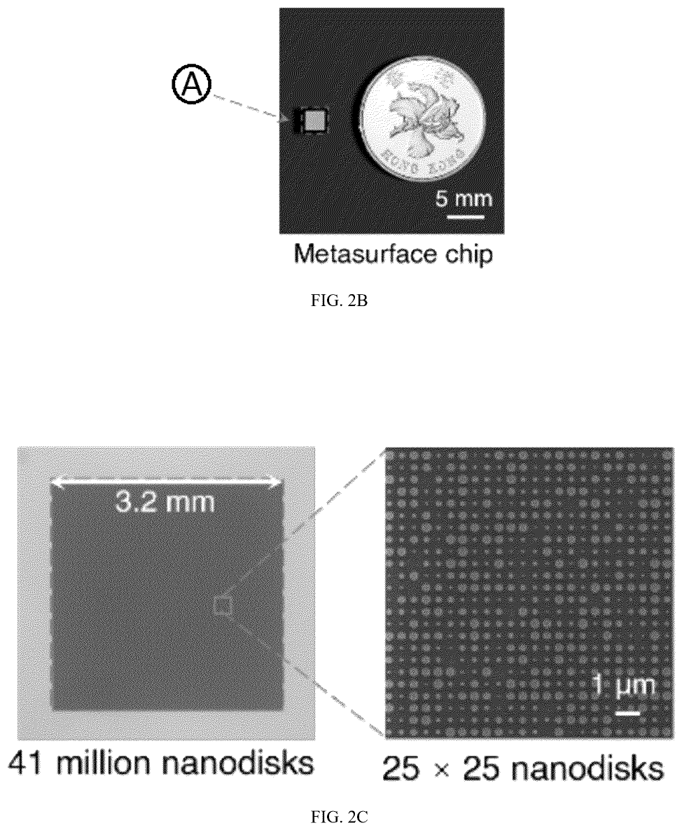

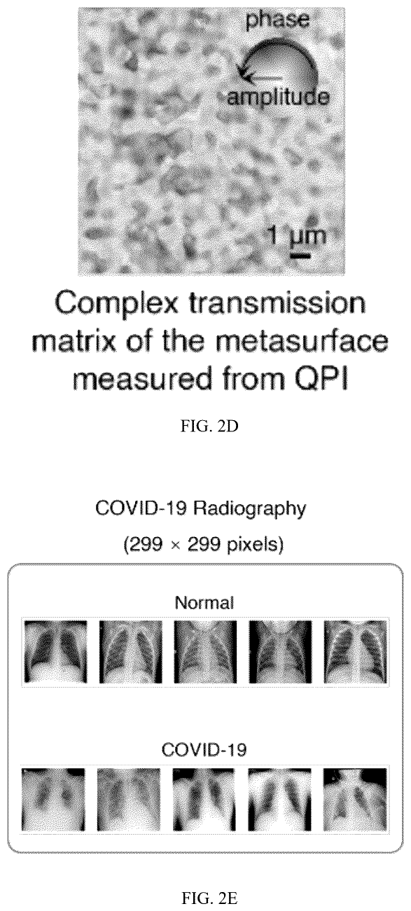

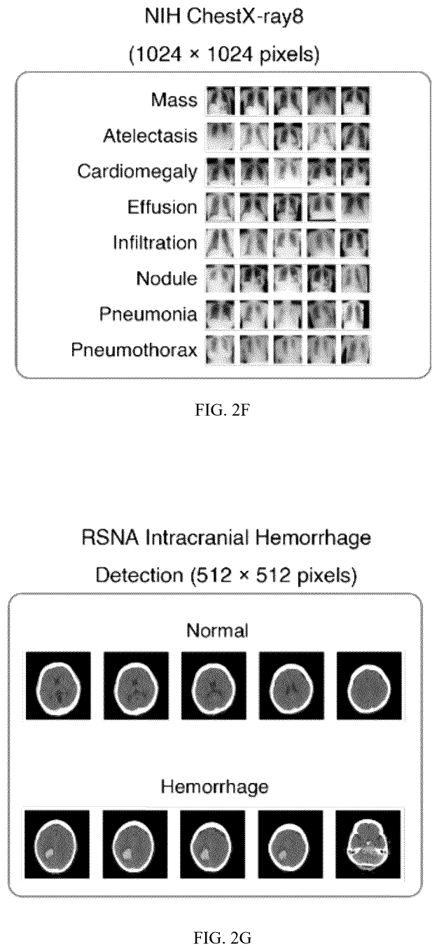

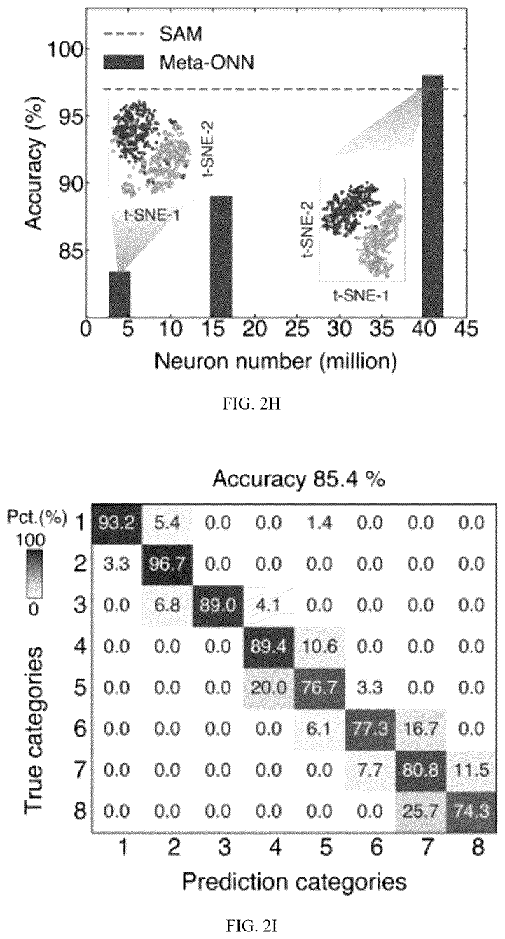

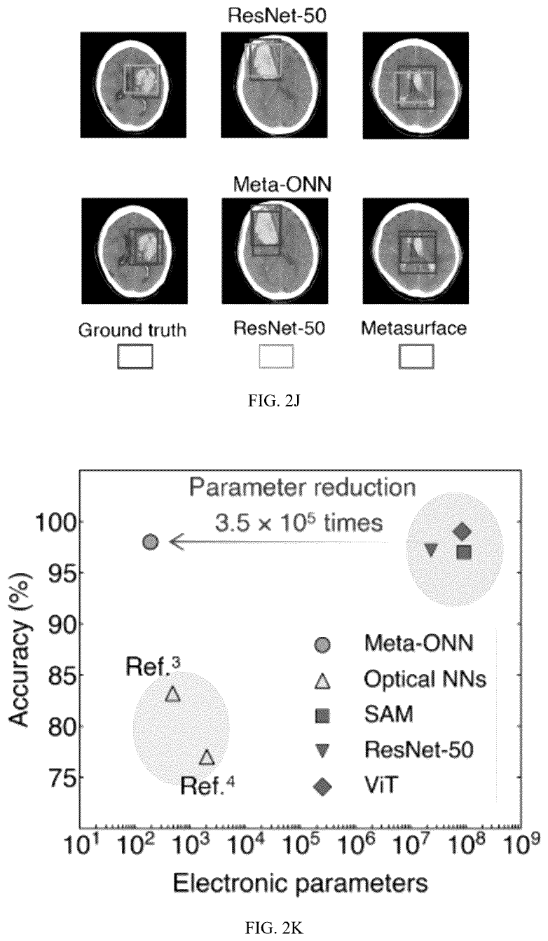

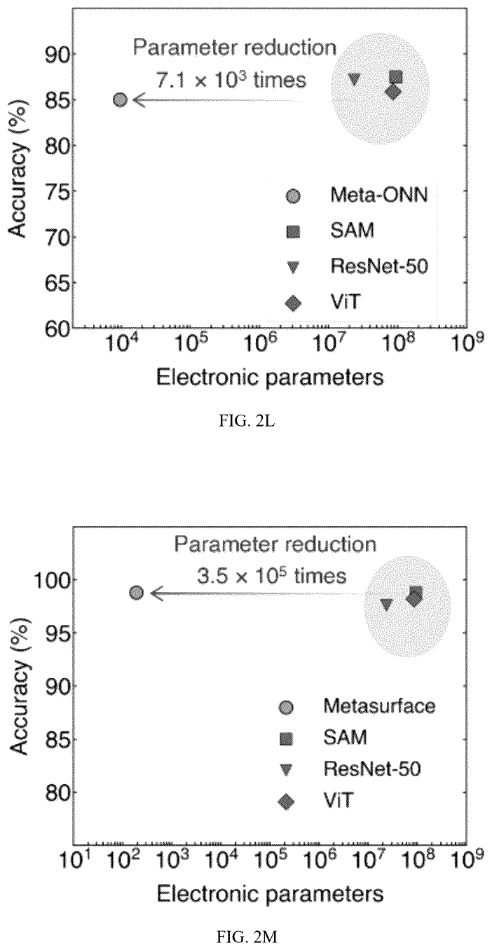

The output of each sensor pixel is

$$= {[ {\sum }_{i = k \cdot R}^{( k + 1 ) \cdot R - 1} F ( {H}_{d} {U}_{0} ⊗ {W}_{meta} ) [ i , : ] ]}^{2} ,$$

where U₀ is the input image, Wₘₑₜₐ is the transmission matrix of the metasurface H is the function for optical diffraction, N is the number of meta-atoms, M is the number of camera pixels, and R is the ratio of these two quantities (R=N/M) and is also the downsampling ratio. This process can be treated as first projecting the original input into an N² dimension space through the above formula and performing sum pooling to downsample the high-dimension space to a M dimension space. This makes the system of the subject invention also function as a universal kernel machine, mapping input images into a N² high-dimensional Fourier feature space. When designing the transmission of each nanodisk, a novel strategy that ensures scalability to 41 million nanodisks without being constrained by physical fabrication errors is adopted. The approach is inspired by the Neural Tangent Kernel (NTK), a theoretical framework for analyzing the behavior of infinitely wide neural networks. NTK theory suggests that when weights are initialized with a Gaussian distribution, they undergo minimal change during training, meaning that Gaussian-initialized weights, even without training, are already close to the global minimum. Therefore, instead of training the metasurface for specific tasks, the weights are designed to directly follow a Gaussian distribution. This approach requires only the transmission matrix to match a Gaussian distribution, eliminating the need for precise tuning of each individual meta-atom. As a result, the system gains remarkable flexibility, enabling the meta-ONN to scale without being limited by fabrication and implementation errors, and allowing expansion to arbitrary widths, depths, and highly complex neural network models. The fabricated metasurface comprise 6,400×6,400=41 million silicon nanodisks, of which diameter is designed to be varied from 100 to 400 nm at a unit cell's period of 500 nm, as shown in FIG. 2C. These nanodisks are designed to provide a complex-valued transmission matrix randomly sampled from a Gaussian distribution. The standard deviation of this Gaussian distribution is designed as large as 0.4π to ensure a higher degree of randomness and thus support high performance. The measured complex-valued transmission matrix of the metasurface is shown in FIG. 2D. The insertion loss of the whole optical system is measured as 7.22 dB, which can be reduced by using low-loss materials, for example, sapphire and titanium dioxide.

The system of the subject invention has three critical aspects leading to its excellent performances compared to the existing systems. First, the introduction of a metasurface provides, in practice, an infinitely wide layer to encode the input into an extremely high-dimensional space over 41 million, a scale never demonstrated in prior systems. Second, employment of the metasurfaces provides full controllability of each entry (meta-atom) to optimize the projection matrices by ensuring that the NN is initialized with Gaussian distribution, as opposed to solely relying on the random nature of a physical system including random scattering media and multi-mode optical fibers, where the optical behavior cannot be precisely engineered to achieve the desired Gaussian distribution, ultimately degrading performance. Third, an optical lens is adopted to provide a Fourier transform, which is critical for the system to learn high-frequency functions. These distinctions enable a single-layer metasurface to rival cutting-edge NN models with many nonlinear layers, such as ResNet and Vision Transformer—a performance that has never been realized in the existing ONN systems. With these unique distinctions, the system of the subject invention exhibits properties not observed in current ONNs, and these advantages are validated using Neural Tangent Kernel (NTK) theory by analyzing the eigenvalues of NTK across different frequencies, where higher eigenvalues indicate greater learning.

These advantages are further demonstrated through MNIST digit classification as a benchmark. First, with 41 million nanodisks, a single-layer NN exhibits behavior equivalent to, or even surpassing, that of a multi-layered neural network. To illustrate this, the NTK is calculated for three systems: (1) a single-layer optical ONN with 41 million nodes, (2) a single-layer ONN with 4 million nodes, and (3) a multi-layer diffractive neural network (DNN), as shown in FIG. 1C. The results show that when the neuron count reaches 41 million, the single-layer ONN matches and even exceeds the performance of a multilayered ONN. Notably, a single-layer ONN achieves an MNIST classification accuracy of 99.6%, outperforming the multi-layered ONN. Moreover, multi-layered ONNs often face significant challenges related to the precise alignment of different layers, which can degrade overall system performance during implementation. Second, when the neuron count reaches 41 million and the initial weights are distributed according to a Gaussian distribution, the NN can achieve comparable and satisfactory performance to a trained network, even without any training process. FIG. 1C shows the changes in the NTK during training. When the neuron count reaches 41 million and the initial weights follow a Gaussian distribution (as in the system of the subject invention), the NTK remains nearly unchanged before and after training. This indicates that the system of the subject invention, even without training, the NN can provide a matched performance with that with training. This behavior aligns with NTK theory for infinitely wide NNs. An impressively high accuracy of 99.3% under the M NIST task using one training-free metasurface chip and only 3,000 trained digital weights is experimentally achieved, surpassing the current ONNs, as shown in Table A1. This property is valid only when the weights are initialized with a Gaussian distribution and with 41 million nodes, as shown in FIG. 1C. In contrast, when the neuron count is limited, as in the case of a 5-layer diffractive NN with a total of 1 million neurons, training becomes essential for improving accuracy. This training-free neural network is generic rather than task-specific, allowing a compact digital layer to be attached to ensure both versatility and high performance. Third, the system of the subject invention includes a lens that performs Fourier feature mapping within the optical domain. This Fourier feature mapping layer enhances the system's ability to learn high frequency features, and therefore provides even better performance compared to multilayered NN. As shown in FIG. 1D, incorporating the lens significantly increases the eigenvalues, particularly in the high-frequency region. This suggests that the lens enhances the ability to learn high-frequency components of the information. Consequently, accuracy is improved accordingly, as shown in FIG. 1E.

TABLE A1
The performance comparison of the meta-ONN with the state-of-the-art ONN systems

| | | | Processed data | # of | | Task |
|---|---|---|---|---|---|---|
| References | Methods | Dataset | size² | neurons | Task type | performance |
| Huang 2021 [1] | 2D | FNC¹ | 1 × 1 | 8 | Classification | N/A |
| Shen 2017 [2] | integrated | Vowel | 1 × 4 | 16 | | 76.7% |
| Ashtiani 2022 [3] | photonics | EMNIST | 3 × 4 | 9 | | 89.9% |
| Feldmann 2021 [4] | | MNIST | 28 × 28 | 16 | | 95.3% |
| Moralis 2022 [5] | | CIFAR-10 | 32 × 32 | 7 | | 79.8%³ |
| Lin 2018 [6] | 3D free- | EMNIST | 28 × 28 | 2 × 10⁵ | Classification | 91.75% |
| Wei 2023 [7] | space | CIFAR-10 | 32 × 32 | 3.9 × 10⁴ | | 73.12% |
| Zhou 2021 [8] | photonics | KTH | 120 × 160 | 4.9 × 10⁵ | | 96.3% |
| Antonik 2019 [9] | | KTH | 120 × 160 | 1.6 × 10³ | | 91.3% |
| Tegin 2021 [10] | Multimode | COVID-19 | 299 × 299 | N/A | Classification | 83.2% |
| Oguz 2022 [11] | optical fiber | COVID-19 | 299 × 299 | N/A | | 77% |
| Luo 2022 [12] | Optical | MNIST | 28 × 28 | 7.84 × 10⁴ | Classification | 93.75% |
| Qu 2022 [13] | metasurface | MNIST | 28 × 28 | 1.25 × 10⁴ | | 98.05% |
| Zheng 2022 [14] | | MNIST | 28 × 28 | 6.27 × 10⁵ | | 93.1% |
| Zheng 2024 [15] | | MNIST | 28 × 28 | 3.39 × 10⁵ | | 98.6% |
| This work | Optical | MNIST | 28 × 28 | 4.1 × 10⁷ | Classification | 99.3% |
| | metasurface | KTH | 120 × 160 | | | 99.1% |
| | | COVID-19 | 299 × 299 | | | 97.0% |
| | | Brain ICH | 512 × 512 | | | 97.8% |
| | | ChestX-ray8 | 1,024 × 1,024 | | | 85.4% |
| | | Brain ICH | 512 × 512 | | Localization | IOU = 0.61 |
| | | CAMELYON | 2 billion pixels⁵ | | Segmentation | IOU = 0.60 |

¹FNC represents the optical communication data for fiber nonlinearity compensation.
²The processed data size refers to the original data size of the dataset, instead of the data size that can be loaded into the ONN at one time.
³The accuracy is experimentally obtained based on the two-categorized CIFA R-10 dataset, and the image is preprocessed by an electrical convolutional neural network before being fed into the ONN.
⁴The accuracy is experimentally obtained based on the four-categorized M NIST dataset.
⁵The whole slide image (WSI) from the CAMELY ON-16 dataset has ~2 billion pixels, which are cropped into many sub-images with 1,000 × 1,000 pixels that our system can process in one shot.
# represents number.

In contrast, the meta-ONN according to the embodiments of the subject invention eliminates the need for meticulous training and precise alignment. This is achieved through adopting random projection strategy. In the system according to the embodiments of the subject invention, the optical metasurface projects the input into a lower-dimensional subspace, followed by a highly compact neural network that generates the final decision. This approach also allows the meta-ONN of the subject invention to be versatile across multiple tasks with the same metasurface design, as demonstrated by the six tasks below.

This approach shares similarities to reservoir computing, a computing architecture implemented by various optical systems. However, the meta-ONN according to the embodiments of the subject invention introduces two critical differences compared to many conventional reservoir computing systems. First, instead of relying solely on the physics of a system without control, the meta-ONN according to the embodiments of the subject invention provides full designability and controllability to optimize each meta-atom for the projection matrices. Second, the meta-ONN offers an abundance of free parameters for optimization. These two distinctions enable the single-layer metasurface to rival cutting-edge neural network models with numerous nonlinear layers, a performance that has never been realized in the existing ONN systems.

In implementing the meta-ONN of the subject invention, the circular silicon posts are engineered by varying transmission coefficients and phases by adjusting the diameters varying from 100 nm to 400 nm at a fixed unit cell period of 500 nm. This approach provides the controllability to optimize the projection matrices, rather than relying solely on the random nature of a physical system. By designing the geometry distribution of the circular silicon posts, the corresponding matrix are ensured to attain an optimized distribution. This strategy not only eliminates the need for cumbersome training but also enables the meta-ONN of the subject invention to be generally applicable to multiple tasks, as demonstrated below.

### Example 2—Rival Deep Neural Networks with a Single-Layer Meta-ONN

First, machine vision tasks are conducted to demonstrate the high performance, versality, and high scalability of the system of the subject invention. For benchmarking purposes, the performance of the meta-ONN is compared against three benchmarking large-scale deep learning models: ResNet-50, a classical 50-layered CNN with approximately 23.5 million parameters; the Segment Anything model (SAM), a cutting-edge large promotable segmentation model with 93.7 million parameters; and Vision Transformer (ViT), a transformer encoder model for image classification with more than 85.8 million parameters.

For each task, the input images are generated using a SLM. Then, these images are processed by the metasurface and collected by an optical lens before being detected by a CM OS digital camera. The detected digital image is downsampled, with the downsampling ratios being task-dependent. The same metasurface chip is used for all the tasks. Only the digital neural network at the backend is trained for different applications.

FIG. 2A shows a schematic representation of the experimental setup of meta-ONN for the benchmark task and FIG. 2B shows an image of the metasurface chip compared with a Hong Kong dollar coin.

COVID-19 Radiography: the applications of the meta-ONN according to the embodiments of the subject invention are further explored by applying it to the COVID-19 Radiography dataset as shown in FIG. 2E. This dataset includes over 20,000 chest X-ray (CX R) images covering normal and COVID-19 positive cases, each with 299×299 pixels. Using the same experimental setup as with CIFAR-10, the optical images of size 299×299 are generated by the spatial light modulator, processed by the meta-ONN, and subsequently detected. The detected image undergoes a dramatic downsampling to only 80 pixels, followed by highly-compact regression network with a size of 80×1 at the digital backend to produce the binary classification results for normal and viral pneumonia cases. An accuracy of 97.0% is achieved using only 80 digitally trained weights, outperforming previously demonstrated simulation and experimental ONNs. This accuracy is comparable with these of ResNet-50 (97.0%) and SAM (97.2%) and slightly lower than the accuracy of ViT (99.0%), which are trained using the same dataset. Nevertheless, the meta-ONN according to the embodiments of the subject invention can compress the digital model by a factor of a 4.9×10⁵ compared to ResNet-50 and 1.8×10⁶ compared to ViT, signifying a remarkable reduction of computing time and energy consumption by 10⁶ times at the training stage and 10⁵ times at the inference stage.

The accuracy, precision, sensitivity, and specificity obtained from the classification results are 98.0%, 96.8%, 99.2%, and 96.9% using only 192 digitally trained weights, respectively. The experimentally obtained accuracy of meta-ONN up to 98.0%, outperforms previously demonstrated simulation and experimental ONNs, as shown in FIG. 2K. This accuracy is competitive against ResNet-50 (97.0%) and SAM (97.2%) and slightly lower than VIT (99.0%). Nevertheless, the meta-ONN of the subject invention can compress the digital model by a factor of 4.9×10⁵ compared to ResNet-50 and 1.8×10⁶ compared to ViT, signifying a remarkable reduction of computing time by 1.2×10⁵ times at the training stage and energy consumption by 1,900 times at the inference stage. The computing time includes the time required for SLM response, the free-space propagation of the light, camera response, and executing a digital computer, respectively. The energy consumption includes the energy consumed by the laser source, SLM, camera, and digital computer, respectively. It is further demonstrated that the substantial number of optical weights unique to the metasurface device is the key factor contributing to the high accuracy. The accuracy increases from 83.0% to 98.0% as the optical weight number increases from 4.2 million to 41 million as shown in FIG. 2H. To gain deeper insights into the data, t-distributed stochastic neighbor embedding (t-SN E) is employed to visualize the data after being processed by the meta-ONN, where the original images are transformed into a lower-dimensional space by the metasurface. As shown in the inset graphs of FIG. 2I, the separation between different classes becomes highly distinct as the weight number increases substantially to 41 million.

Encouraged by the performance being achieved, the more challenging applications that have never been demonstrated by ONNs have been investigated. These tasks showcase the meta-ONN's ability to process the high-resolution images and tackle more challenging medical diagnostic tasks.

Thoracic diseases detection: The NIH ChestX-Ray8 dataset comprises high-resolution (1024×1024 pixels) front-view X-ray images covering eight different thoracic diseases. It is demonstrated that these commonly occurring thoracic diseases can be detected by the meta-ONN of the subject invention with an average accuracy of 85.0%, followed by a small digital processing using 9,600 digitally trained weights. The achieved accuracy is comparable to the results obtained by ViT (accuracy of 85.8%) employing 85.8 million digitally trained weights. The result suggested that the digital network is compressed by a factor of 8.9×10³ in this task. Additionally, this task highlights the meta-ONN's ability to process high-resolution images without any pre-processing, utilizing a 1024×1024 pixel resolution—the highest demonstrated by ONNs up to date.

Intracranial Hemorrhage Detection: Intracranial hemorrhage (ICH) is a critical medical condition that requires rapid and intensive treatment to prevent further damage and enhance patient outcomes. However, the timely detection of ICHs is often delayed due to a lack of prompt access to radiologists who read the scans. Here, the meta-ONN according to the embodiments of the subject invention is leveraged to expedite ICH detection in CT images.

This approach comprises two tasks. In the first task, the existence of hemorrhages in CT images is detected, achieving an AUC of 97.6% with a digital weight number of only 4 and 99.9% with an increased weight number of 80, as shown in FIG. 2H. The accuracy of ICH classification is 97.8% with 80 weight number.

The experiments undertake two tasks. In the first task, the existence of hemorrhages in CT images is detected, achieving an accuracy of 98.8%, a precision of 98.5%, a sensitivity of 99.2%, and a specificity of 98.3%.

In the second task, the bleeding point location with the meta-ONN is identified. First, the optical images after meta-ONN are downsampled to 15×20 pixels. These downsampled images serve as the input to a 6-layered fully connected neural network at the digital backend. The output is a 1×4 vector, each element representing the horizontal and vertical position coordinates, width, and height of a rectangular box. The box indicates the bleeding region in the CT images, as shown in FIG. 2J. Intersection over Union (IoU) is obtained from the predicted box and the true box to evaluate the performance of the bleeding region localization. Here, IoU is the ratio of the overlapped area over the united area of the two boxes. The meta-ONN according to the embodiments of the subject invention achieves an averaged Intersection over Union (IoU) of 0.61 for 3 different bleeding positions, meaning that the predicted bounding box indicating that the bleeding location well aligns with the ground truth box. In comparison, the averaged IOU obtained by ResNet-50 is 0.64.

An important discovery implied by the results of the meta-ONN of the subject invention across diverse vision tasks is its capacity to rival cutting-edge neural network models with tens of million parameters, using only a single-layer metasurface. It is experimentally validated by different tasks that the superior performance of the meta-ONN according to the embodiments of the subject invention is credited to the massive parameters uniquely offered by the metasurface, as demonstrated in FIGS. 2K-2M. While a small neural network is still necessary at the digital backend, its size can be highly compressed. This signifies that latency and energy consumption can be reduced by up to hundreds of thousands of times. It is worth noting that the remaining parameters can be readily implemented in analog devices, enabling the realization of an all-analog system.

Leveraging on these advantages, it is further demonstrated that the meta-ONN according to embodiments of the subject invention can be applied to two real-world scenarios, showcasing its remarkable and distinct benefits in computationally intensive applications.

### Example 3—Scalable to Complexed NN Models for High-Accuracy Video Sequence Processing

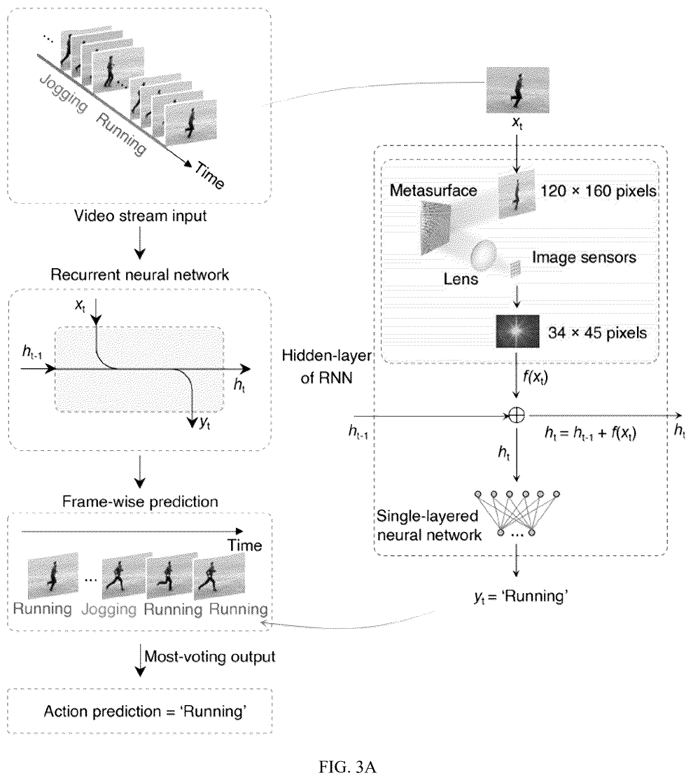

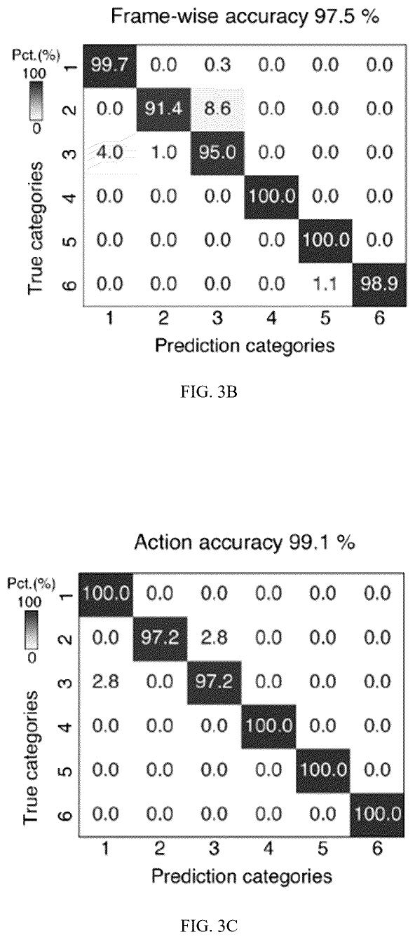

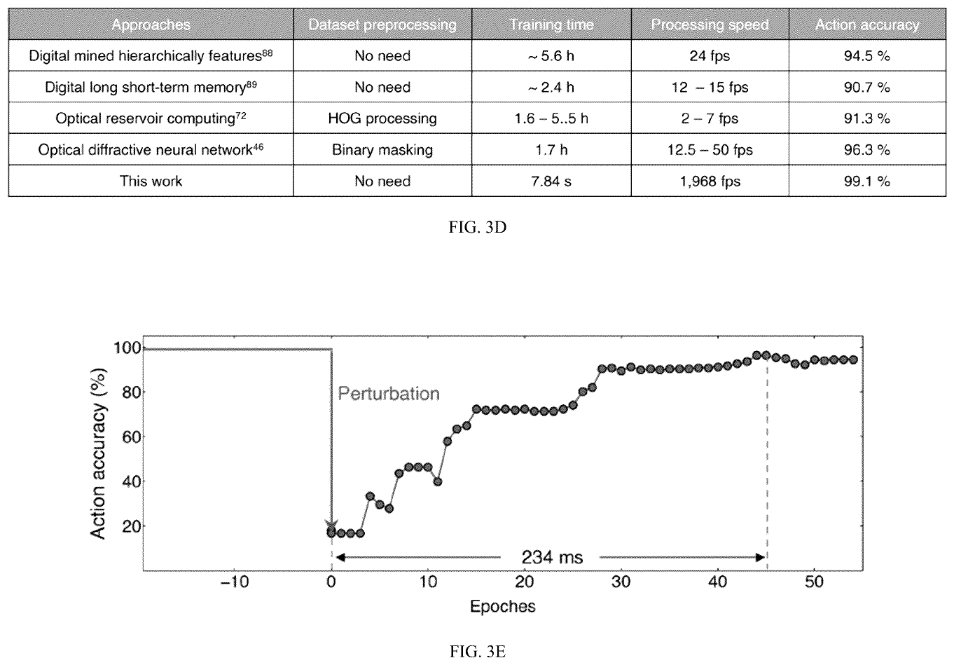

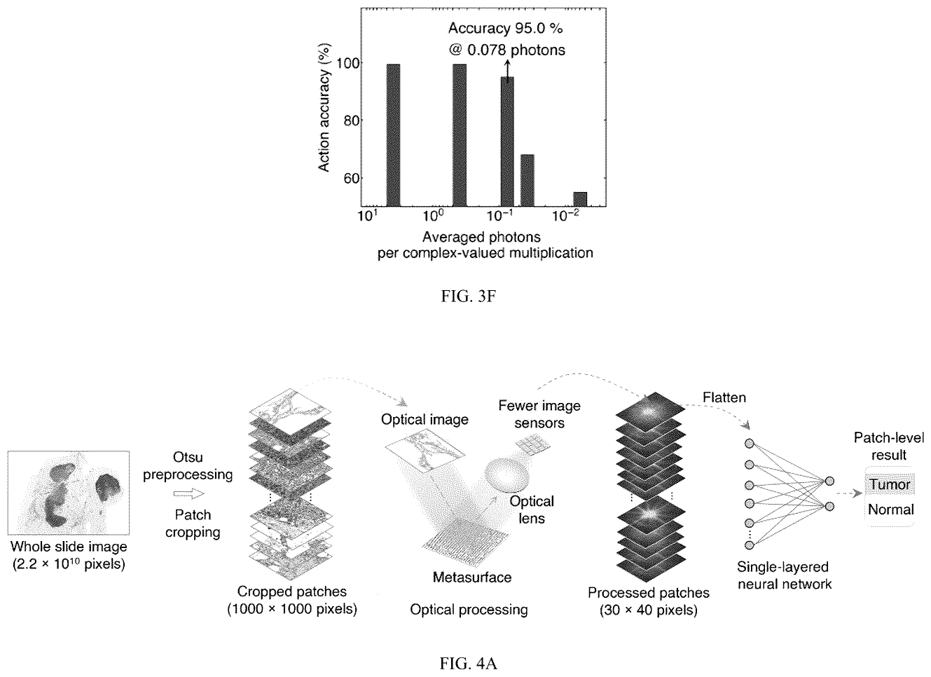

Leveraging random projection, we can confidently increase the depth of the optical NN without concerns about physical errors accumulating layer by layer. This allows the system of the subject invention to tackle more complicated AI tasks. Here we construct a recurrent neural network (RNN) using metasurface-based ONN and apply it in video processing. Serving as a hidden layer, the ONN is recurrently connected to form an RNN. Serving as a hidden layer, the meta-ONN is recurrently connected to form a recurrent neural network (RNN). This meta-RNN takes a sequence of image frames from a video as input, as shown in FIG. 3A. Each frame undergoes processing by the meta-RNN, with the output being downsampled and read out from the camera. Subsequently, this output is combined with the hidden state from previous frames to derive the hidden state of the current frame. Finally, the output of the hidden state is connected to a logistic regression-based classifier. The meta-ONN is employed for human action recognition tasks on the KTH dataset, which comprises six types of human actions across four different scenarios. The evaluation of the model's performance involves two types of action classification. One type identifies actions jointly determined by sequences of frames, defined as action accuracy. The action is determined from the percentage of votes for all actions in each testing video sequence. The action with the maximum votes is the predicted action in a video sequence. The other type identifies the action indicated by each individual frame, defined as frame accuracy. With 9180 trained weights, the meta-RNN obtains a frame accuracy of 97.5% and an action accuracy of 99.1%, as shown in FIGS. 3B and 3C, respectively. The training time is only 4.01 seconds using Geforce RTX 3090. The obtained accuracy excels digital NNs using long-short term memory (action accuracy of 90.7%) and the state-of-the-art ONNs (action accuracy of 96.3%). Additionally, the meta-ONN according to the embodiments of the subject invention can directly process videos without the need for pre-processing required by other ONNs. Consequently, the meta-ONN is capable of processing videos at a high speed, achieving 120,192 frames per second.

The training time to realize such a high accuracy is only 4.01 seconds using NVIDIA RTX 3090. The obtained accuracy exceeds those from digital NNs using long-short term memory (action accuracy of 90.7%) and the existing ONNs (action accuracy of 96.3%). Additionally, unlike the existing ONNs that typically need preprocessing of the frames of the action sequences by pre-trained CNN for human segmentation, the meta-ONN can directly process videos without the need for such preprocessing steps. Consequently, the meta-ONN of the subject invention is capable of processing videos at high speed, achieving 1,968 frames per second.

Referring to FIG. 3D, performance comparison of the meta-ONN against the existing digital and optical approaches are demonstrated, wherein the training time and processing speed of the meta-RNN are the predicted ones based on current experimental results.

This task is further utilized to demonstrate the capability of the ONN of the subject invention to rapidly recover from external perturbations and its potential for real-time adaptable learning. To show this property, the metasurface is intentionally moved by 10 μm creating the axial misalignment after the digital NN is trained. The misalignment is 20 times the wavelength of the light. The axial misalignment results in a change in the modulation matrix of the metasurface, which may lead to the degradation of the accuracy by 16.7%. However, the meta-ONN is capable of quickly recovering from the error after re-training the single-layer digital NN as shown in FIG. 3E. The accuracy is restored to 96.3% after 45 epochs using only 1,920 training images, which takes only 234 ms. This study highlights the adaptability of the meta-ONN, even in dynamic or unpredictable environments and its potential for real-time adaptable learning. Computing very large matrices with optical fan-in allows for extremely low optical energy consumption. If the matrix size is sufficiently large, each multiplication requires a photon number far less than 1. In FIG. 3F, it is shown that an average photon number of 0.078 per multiplication is sufficient to maintain human action classification accuracy over 95%, making the system suitable for low-illumination environments.

### Example 4—Solving Real-World Challenges: Accelerating the Analysis of Multi-Gigapixel Whole Slide Images for Cancer Diagnosis

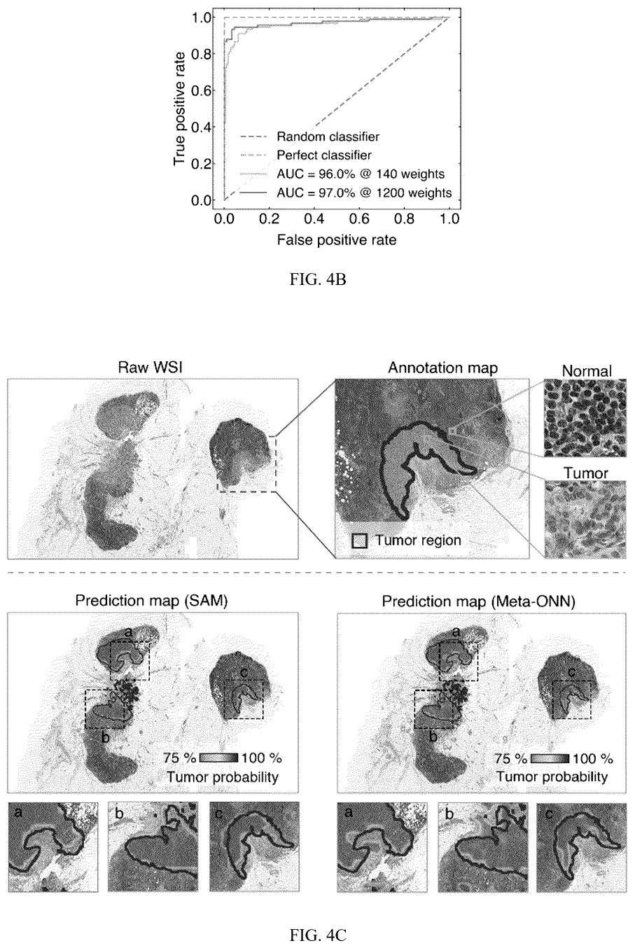

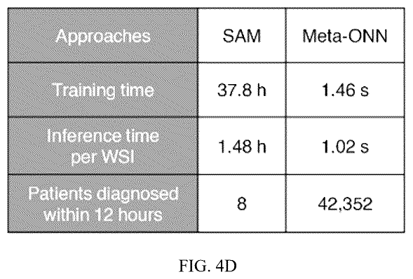

Leveraging these advantages, it is finally demonstrated that the application of the meta-ONN of the subject invention in a real-world challenge, showcasing its distinct benefits in computationally intensive applications. For many diseases, particularly cancers, pathological diagnosis is the gold standard in clinical practice. The introduction of Whole Slide Imaging (WSI) scanners, which generate digitized pathology microscopic images, has revolutionized pathology image analysis. The technology enables computer-aided diagnostics, leveraging advanced deep-learning techniques to reduce the workload of pathologists and optimize the regional distribution of medical resources. However, WSIs present a challenge for deep learning due to their extremely large size. With single slides containing multi-gigapixel images, efficient processing of these images is crucial for automated diagnosis. A meta-ONN is applied to detect and localize breast cancer that has metastasized to nearby lymph nodes, a task of significant clinical importance but requiring substantial reading time from pathologists. Pathologists generally need to review thousands of megapixel photos from a single WSI exceeding 10 gigapixels. The CAMELYON16 dataset is adopted for the study. To address the processing of extensive WSIs, each with dimensions of more than 2 billion pixels, a patch-based framework is employed. Initially, a preprocessing algorithm, Otsu algorithm, is used to separate the raw whole slide image into the useful foreground and the non-tissue background, resulting in a reduced total pixel of the whole slide image to be processed, as shown in FIG. 4A. Then, the large WSIs are divided into smaller patches, each containing 1,000×1,000 pixels. These patches comprise 1,775 normal patches and 887 tumor patches. During the training phase, the patches are converted into optical images using the SLM. The modulated patch samples are processed by the meta-ONN and detected by the sensor array. Subsequently, the output from the sensor array is downsampled. The final step is to train a single-layered neural network with the patch samples to create a classifier capable of distinguishing between normal and tumor classes. The mean AUC is 96.0% when the trained weight number is 140 and increases to 97.0% at the weight number of 1,200, as shown in FIG. 4B. The training process takes only 1.46 s, achieving a training accuracy of 95.1%, as shown in FIG. 4D. Another WSI comprising 2,030 unlabeled patches is used to test the performance of tumor tissue segmentation. Initially, these unlabeled patches are first processed using the meta-ONN. Subsequently, the processed patches are inferred with the trained single-layered NN to produce the tumor-positive probability. Finally, the probability heat map is generated by mapping the predicted probability of the patches to the raw WSI. As shown in FIG. 4C, the resulting heat map demonstrates that the meta-ONN achieves accurate segmentation of three different tumor tissue regions from the billion-pixel-scale WSI, achieving an IOU of 0.60, which is comparable to that of SAM (0.63). More importantly, the meta-ONN exhibits an impressively fast inference time of 1.02 s per whole slide image (WSI), representing a significant reduction compared to SAM which requires 1.48 hours to analyze one WSI. This remarkable reduction in inference time allows the meta-ONN to diagnose more than 42,352 patients within a single 12-hour working day, while only 8 patients can be diagnosed using SAM in the same timeframe.

### Discussion

It is experimentally demonstrated that a high-performance ONN can provide unprecedented accuracy, energy efficiency, and computing throughput. These exceptional performances are a result of realizing a true large-scale optical computing system by innovatively combining optical metasurfaces, a device fully leveraging the parallelism of optics, with random projection, a computing framework suitable for metasurface-based NNs to scale to arbitrary widths, depths, and complexity. An important observation from the experimental demonstration is that a single-layer optical metasurface chip, integrating 41 million optical neurons, can achieve competitive performance compared to the existing deep NNs such as ResNet and ViT. This result may alleviate current bottlenecks in extending ONNs to deeper layers, as realizing the nonlinearities between layers remains a significant challenge in ONN systems.

The ability to realize large-scale AI models is often crucial for solving challenging tasks to meet downstream application requirements. The system and methods of the subject invention represent a significant advancement, moving ONNs beyond benchmark demonstrations to effectively address real-world challenges. The performance comparison of the meta-ONN with the existing ONN systems is shown in Table AI. By computing 41 million optical neurons in a single operation, the system experimentally achieves a computing throughout exceeding 4,700 Tera operations per second. The neuron capacity and operation speed of the meta-ONN could be further improved by serval orders of magnitude. For example, neurons can easily be scaled up to 1.6 billion using a larger footprint metasurface (20×20 mm²) with a commercially available fabrication process. Vertical cavity surface-emitting laser (VCSEL) arrays have demonstrated the ability to operate at the quantum-noise limit and achieve high speeds in the GHz range. The computing throughput could be further enhanced by leveraging the state-of-the-art high-speed VCSEL arrays. The system loads over 99.99% computations on a passive optical metasurface. Although a small digital NN is still required at the backend, the time for training such as NN is greatly shortened from tens of hours to a few seconds. If high-speed SLMs and cameras are used, the training time could be reduced to only tens of milliseconds. This makes the system of the subject invention highly adaptable to dynamic or unpredictable environments that require real-time learning abilities, such as robot-assisted surgery. Meanwhile, the inference time could easily be improved to the microsecond or even submicrosecond level, which could enable a range of applications involving high-speed objects and requiring real-time decisions. Even shorter training and inference times could be achieved using delicate neural network accelerators realized with field-programmable gate arrays (FPGAs) and analog electronics. The sub-wavelength optical metasurface is much thinner and smaller than bulk optical devices. This allows for a highly compact integration with the CMOS sensors and thus a minimized system volume of the meta-ONN system. The system volume of a free-space-based ONN is defined as the area of the free-space optical device multiplied by the spacing distance between the optical device and the COMS camera. In the current experiment setup, which uses a reflective metasurface, the reduction of volume is hindered by the use of a beam splitter, resulting in a system volume of 2,560 mm³. In an improved design, the metasurface could be designed to work in a transmissive way by using a transparent substrate, for example, sapphire and quartz, eliminating the requirement for the beam splitter. The distance between the metasurface and the converging lens may be shortened. In addition, the bulky converging lens could be replaced with a thin metalens with a high numerical aperture of 0.99. Considering that the metalens needs to fully cover the metasurface with a squared area of 3.2×3.2 mm², the diameter of the metalens is 4.5 mm and the focal length is 2.27 mm. The minimum distance between the metasurface and the lens can be equal to the metasurface size of 3.2 mm, which enables the all-to-all connection of optical weights during light diffraction. The spacing between the metasurface and the camera can be as small as 5.47 mm. As a result, the system volume could be extremely shrunk to 56 mm³. which is more compact by 102 to 104 times than the existing 3D free-space-based ONN systems. This compact volume allows the optical system to be fully integrated with the following electronics and optoelectronics.

One of the advantages of the meta-ONN is the ability to work under wide-spectral light conditions. The optical response of metasurfaces is wavelength-dependent. Different wavelengths will introduce the error of the optical response from the optimized one, which causes performance degradation in conventional metasurfaces that need to be precisely designed for a specific task. However, the meta-ONN integrates with 41 million meta-atoms that are randomly initialized with a Gaussian distribution, without the need for precise designs. The error arising from the wavelength dependence will not affect the performance of the meta-ONN. This property allows the meta-ONN to operate under the experimental light source with a wide spectral width of 10 nm. It is important to note that the ability to work at a large spectral width is demanded in practical applications involving incoherent light containing multiple wavelengths.

### Methods for Metasurface Design and Simulation

The metasurface is created using massive periodic unit cells. Every unit cell comprises a 220-nm-thick silicon cylindrical nanodisk with a diameter that varies across different cells. The silicon nanodisk is deposited on a 2-μm-thick buried oxide layer on a 725-μm thick silicon substrate. These unit cells are arranged in a square lattice in the two-dimensional plane. The period of the metasurface unit cell is 500 nm. Based on three-dimensional FDTD simulations, the optical phase and amplitude modulation coefficients of the unit cell for the incident light are obtained at various diameters under normal incidence. The simulation result indicates that the optical phase and amplitude of the incident light can be effectively manipulated by varying the diameter of the nanodisk. The fabricated metasurface comprises 6400×6400=41 million nanodisks. The diameter of every nanodisk is independently designed to realize the optical phase and amplitude modulation coefficients following a Gaussian sampling distribution. Specifically, the standard deviation of the Gaussian distribution of phase modulation is designed as 0.4π. With the designed phase distribution, the diameter of every nanodisk can be obtained according to the mapping relationship between the optical phase and nanodisk diameter. The range of the nanodisk diameters is from 100 nm to 400 nm. The amplitude distribution is also determined without the need for further designs according to the relationship between optical amplitude and nanodisk diameter.

### Numerical Simulations of Neural Tangent Kernel (NTK) Tested Under the MNIST Task

The meta-ONN can be treated as an infinitely wide ONN, which has been mathematically modeled using the diffraction theory. The NTK of the meta-ONN is the inner product between the partial derivative of the two different model outputs Y to the trainable phase of the metasurface φ_{MS}, which is calculated by the following equation:

$$NTK ( i , j ) = 〈 \frac{\partial Y ( {X}_{i} ; {φ}_{MS} )}{\partial {φ}_{MS}} , \frac{\partial Y ( {X}_{j} ; {φ}_{MS}}{\partial {φ}_{MS}} 〉 ,$$

where Xᵢ and Xⱼ are the two different model inputs, respectively. The model of the ONN is constructed using the mathematical expression of the output of the image sensor. In the simulations, 9,000 MNIST images are used to train the meta-ONN with a learning rate of 5×10⁻³. Another 100 images are used to obtain the NTK during the training process. The NTK's dimension is 100×100. The NTK's eigenvalue determines the loss of a neural network during the training stage, according to the following equation: [symbol] ∝−e^{-ηλ}^{_{NTK}}^{t}, where [symbol] is the training loss of the NN, n is the learning rate, λ_{NTK} is the eigenvalue of NTK, and t is the training iteration. This means that a higher eigenvalue enables a faster convergence of the NN, representing a stronger learning ability. The trained ONN is evaluated to obtain classification accuracy using 1,000 MNIST images, which are randomly extracted from the entire MNIST dataset. The decision layer for producing prediction results has 1,000 digital weights.

### Method for Metasurface Fabrication

The metasurface chip is fabricated based on a multi-project-wafer (MPW) process offered by a commercial electron-beam-lithography based silicon foundry. The fabrication process starts with a silicon-on-insulator (SOI) wafer, where the device layer thickness is 220 nm, the buffer oxide layer thickness is 2 μm, and the silicon substrate thickness is 725 μm. A layer of electron-sensitive resist is coated on the device layer of the wafer, followed by heating to strengthen the resist. After that, a 100 keV electron gun is used to define the nanodisk patterns of the metasurface. The wafer is then chemically developed, and the patterned resist remains on the substrate. Finally, an anisotropic RIE etching process is performed to transfer the pattern of the resist into the silicon device layer. The etching process will continue until the surface of the buffer oxide layer is exposed.

### Quantitative Phase Imaging of the Fabricated Metasurface

Quantitative Phase Imaging (QPI) is used to measure the reflective phase response of the metasurface. The system has a diffraction-limited spatial resolution of 665 nm and a field of view of 36×36 μm2. With a total magnification of 200×, the system achieves a high pixel resolution of 60 nm, thus enabling a clear visualization of the phase modulation matrix.

### Experimental Setup of the Metasurface-Based ONN

The ONN comprises an SLM for optical image generation, a single-layer metasurface chip, a converging lens for coherent summation, and a camera for optical image capture. The experiment setup starts with a 532-nm laser diode which emits an optical beam with a diameter of 3 mm and a spectrum with a full width at half maximum (FWHM) of 10 nm. The laser is then collimated using an optical lens and expanded to a diameter of 10 mm using an optical 4-f system. The purpose of expanding the beam diameter is to ensure that the laser beam can effectively cover the active area (15.4 mm×9.6 mm) of the spatial light modulator (SLM, Meadowlark Optics E19x12-400-800-HDM8). The SLM has a full-pixel resolution of 1,920×1,200, a pitch size of 8 μm, and an 8-bit modulation depth. The expanded laser beam enters onto the SLM at an off-axis angle of 12°. By introducing two linear polarizers placed before and after the SLM, the SLM can be used to encode the digital image onto the optical domain. The polarization angle of both polarizers is 45° with respect to the horizontal direction. The SLM-generated optical image is projected onto the metasurface chip. Here, to ensure that the optical image can effectively overlap with the area of the metasurface chip to realize full-area modulation of the optical image, the effective area of the optical image is intentionally set as 4.1×4.1 mm². Two approaches are used to realize the consistent effective area in all the tasks: (1) For the task images whose pixel scale is smaller than 512×512, the images are upsampled to a pixel scale of 512×512 using the nearest area interpolation method in the digital domain. Consequently, the effective area of the optical image is 512× 8 μm×512×8 μm=4.1×4.1 mm². For example, the pixel scale of the COVID-19 image is upsampled to be 512×512 from 299×299. (2) For the task images whose pixel scale is larger than 512×512, the generated optical image is minified to an effective area of 4.1×4.1 mm² using a 4-f system in the optical domain. For example, the Chest X-ray image with a pixel scale of 1024×1024 is minified double. In addition, since the effective area of the optical image is smaller than the laser beam size (10×10 mm²), an aperture of 5.5×5.5 mm² is used to block the stray light of the laser beam. A 50/50 beam splitter is placed between the SLM and the metasurface chip to realize the normal incidence of the optical image to the metasurface. The optical image is reflected by the metasurface and the beam splitter in sequence. Following that, the reflected optical image is focused by an optical converging lens with a focal length of 150 mm. Lastly, a camera (IRVI Contour IR Digital CMOS Camera) with an 8-bit depth and an activated pixel number of 600×800 is placed close to the focal plane of the converging lens to capture the optical image.

### Neural Network Training

In the experiment, the camera-captured images processed by the meta-ONN are fed into a single-layer backend digital neural network to produce the prediction results of various machine vision tasks. First, the captured images are downsampled by averaging the received power in the neighboring sensor array. After that, the down-sampled images and the corresponding labels are combined as the new dataset after the meta-ONN. The dataset is then randomly split into the training dataset and testing dataset by a certain ratio. The training dataset is used to train the digital neural network. The digital neural network comprises an input layer for receiving the input image and an output layer for generating prediction results, and the two layers are fully connected. Biases are added to the output before the activation function of sigmoid. The mathematical expression of the single-layered digital neural network is y=sigmoid(b0+w0x), where b0, w0, x, and y are the biases, the digital weights, the input image in the form of vector and the prediction result, respectively. Logistic regression is used to optimize the biases and digital weights. Finally, the testing datasets used to verify the performance of the overall system. The parameters for downsampling the captured images, the split ratio of the dataset, and the hyperparameters for neural network training are task-dependent.

According to the embodiments of the subject invention, the AI accelerator system for intelligent imaging and machine vision comprising an optical metasurface, an optical lens, an imaging sensor is provided. Further, the method of co-designing and co-training such AI accelerator system is provided. The system and method of the subject invention can speed up both the training and inferencing of various image and video processing by a few orders of magnitude, compared to the capabilities of solely digital processors. The associated energy consumption of the imaging and machine vision system can be reduced by a few orders of magnitude.
Embodiment 1. An optical neural networks (ONNs) system, comprising:
an optical metasurface comprising a plurality of arrays of sub-wavelength meta-atoms, wherein each meta-atom is independently configured to modulate both amplitude and phase of light beams incident to the optical metasurface for performing complex-valued dot products.
Embodiment 2. The ONNs system of embodiment 1, further comprising a focusing lens configured to receive and process light beams output from the optical metasurface.
Embodiment 3. The ONNs system of any preceding embodiment, wherein each meta-atom of the plurality of arrays of sub-wavelength meta-atoms is a sub-wavelength-scale pillar disposed on a two-dimensional plane.
Embodiment 4. The ONNs system of embodiment 3, wherein the pillar is made of silicon or TiO₂ on a SiO₂ substrate and has a cylindrical structure or a cubical structure.
Embodiment 5. The ONNs system of embodiment 3 or 4, wherein when the pillar has a cylindrical structure, the pillar has a diameter configured to finely tune its modulation coefficient.
Embodiment 6. The ONNs system of embodiment 3 or 4, wherein when the pillar has a cubical structure, in-plane angles of cuboid of the pillar are configured to finely tune its modulation coefficient.
Embodiment 7. The ONNs system of any preceding embodiment, wherein each meta-atom of the plurality of arrays of sub-wavelength meta-atoms is configured to act as an optical node for individually modulating a transmissive or reflective phase and amplitude of the input light beams.
Embodiment 8. The ONNs system of embodiment 7, wherein coefficients of the phase and amplitude modulation of each optical node are randomly selected.
Embodiment 9. The ONNs system of any preceding embodiment, wherein the optical metasurface and the focusing lens are configured to transform a raw optical image to a low-dimensional feature map.
Embodiment 10. The ONNs system of embodiment 9, wherein the raw optical image is element-wise modulated by the optical metasurface and then spatial components of the modulated optical image are weighted and linearly summed by spatial Fourier transformation performed by the focusing lens to generate the low-dimensional feature map.
Embodiment 11. The ONNs system of embodiment 9, wherein the raw optical image is element-wise modulated by the optical metasurface and then spatial components of the modulated optical image are weighted and linearly summed by spatial Fourier transformation performed by free-space propagation or another type of optical device.
Embodiment 12. The ONNs system of embodiment 11, wherein the other type of optical device includes diffractive gratings or optical diffusers.
Embodiment 13. The ONNs system of any preceding embodiment, wherein the performing complex-valued dot products is conducted with weights on a scale of millions to billions.
Embodiment 14. The ONNs system of any preceding embodiment, wherein geometry distribution of the plurality of arrays of sub-wavelength meta-atoms is configured such that corresponding matrix are ensured to attain an optimized Gaussian distribution.
Embodiment 15. A system for performing a machine vision task, comprising:
an optical metasurface comprising a plurality of arrays of sub-wavelength meta-atoms, wherein each meta-atom is independently configured to modulate both amplitude and phase of input light beams for performing complex-valued dot products;
a focusing lens configured to receive and process light beams output from the optical metasurface to generate a low-dimensional feature map;
an image sensor array configured to capture the low-dimensional feature map output from the focusing lens and convert the low-dimensional feature map into a feature map of a digital format; and
a digital processor configured to process the feature map of a digital format for performing the machine vision task.
Embodiment 16. The system of embodiment 15, wherein the low-dimensional feature map is down-sampled into the feature map of a digital format with adjustable pixel scales, depending on the machine vision task.
Embodiment 17. The system of embodiment 15 or 16, wherein the image sensor array is configured to perform an optoelectronic nonlinear activation method through square-law detection.
Embodiment 18. The system of any preceding embodiment, wherein the digital processor is configured to be trained by a highly compact neural network to generate a final decision for the machine vision task.
Embodiment 19. The system of any preceding embodiment, wherein the machine vision task is object classification, object detection, or video recognition.
Embodiment 20. An optical neural networks (ONNs) system, comprising:
a single-layer metasurface, onto which an optical image is projected;
an optical lens configured to collect a reflected optical image from the metasurface;
an image sensor array configured to capture an optical field at a focusing plane of the optical lens; and
a digital neural network configured to receive the captured optical field as input and produce a prediction result.
Embodiment 21. The system of embodiment 20, wherein the single-layer metasurface comprises a plurality of cylindrical silicon nanodisks.
Embodiment 22. A meta-optical neural network (meta-ONN) system, comprising:
a metasurface including a plurality of meta-atoms;
wherein the metasurface is configured to perform a computational task under illumination by a wide-spectral light source, and
wherein the plurality of meta-atoms are randomly initialized according to a statistical distribution such that optical response of the metasurface is tolerant to variations in wavelengths of the wide-spectral light source to inhibit performance degradation due to wavelength dependence.
Embodiment 23. The system of embodiment 22, wherein the statistical distribution for initializing the plurality of meta-atoms is a Gaussian distribution.
Embodiment 24. The system of embodiment 22 or 23, wherein a number of meta-atoms in the metasurface equals to or is greater than 41 million.
Embodiment 25. The system of any preceding embodiment, wherein the wide-spectral light source has a spectral width of approximately 10 nm.
Embodiment 26. The system of any preceding embodiment, wherein the meta-ONN performs the computational task without requiring a precise design of meta-atoms for specific wavelengths.
Embodiment 27. The system of any preceding embodiment, wherein the wide-spectral light source is an incoherent light source containing multiple wavelengths.
Embodiment 28. A method for configuring a meta-optical neural network (meta-ONN), comprising:
providing a metasurface comprising a plurality of meta-atoms; and
setting transmission matrix of the metasurface to statistically follow a Gaussian distribution;
wherein the meta-atoms are not precisely tuned for any specific task; and
wherein the meta-ONN is enabled to implement scalable neural network architectures without retraining or reconfiguring the metasurface for different computational tasks.
Embodiment 29. The method of embodiment 28, wherein performance of the meta-ONN is robust to fabrication errors and implementation variability, allowing for expansion to arbitrary widths, depths, and highly complex neural network models.
Embodiment 30. A metasurface for a meta-optical neural network (meta-ONN), comprising:
a two-dimensional array of nanostructures fabricated from silicon;
wherein the two-dimensional array of nanostructures is configured to collectively implement a complex-valued transmission matrix randomly sampled from a Gaussian distribution.
Embodiment 31. The metasurface of embodiment 30, wherein the array comprises tens of millions to billions of nanodisks.
Embodiment 32. The metasurface of embodiment 31, wherein the nanodisks have diameters of hundreds of nanometers within a unit cell period that is approximately equal to the wavelength of the incident light.
Embodiment 33. The metasurface of any preceding embodiment, wherein the Gaussian distribution has a large standard deviation in phase to allow a high degree of randomness.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] Huang, Chaoran, et al. “A silicon photonic-electronic neural network for fibre nonlinearity compensation.” Nature Electronics 4.11 (2021): 837-844.
[2] Shen, Y ichen, et al. “Deep learning with coherent nanophotonic circuits.” Nature photonics 11.7 (2017): 441-446.
[3] Ashtiani, Farshid, Alexander J. Geers, and Firooz Aflatouni. “An on-chip photonic deep neural network for image classification.” Nature 606.7914 (2022): 501-506.
[4] Feldmann, Johannes, et al. “Parallel convolutional processing using an integrated photonic tensor core.” Nature 589.7840 (2021): 52-58.
[5] Moralis-Pegios, Miltiadis, et al. “Neuromorphic silicon photonics and hardware-aware deep learning for high-speed inference.” Journal of Lightwave Technology 40.10 (2022): 3243-3254.
[6] Lin, Xing, et al. “All-optical machine learning using diffractive deep neural networks.” Science 361.6406 (2018): 1004-1008.
[7] Wei, Kaixuan, et al. “Spatially varying nanophotonic neural networks.” Science Advances 10.45 (2024): eadp0391.
[8] Zhou, Tiankuang, et al. “Large-scale neuromorphic optoelectronic computing with a reconfigurable diffractive processing unit.” Nature Photonics 15.5 (2021): 367-373.
[9] Antonik, Piotr, et al. “Human action recognition with a large-scale brain-inspired photonic computer.” Nature Machine Intelligence 1.11 (2019): 530-537.
[10] Teğin, Uğur, et al. “Scalable optical learning operator.” Nature Computational Science 1.8 (2021): 542-549.
[11] Oguz, Ilker, et al. “Programming nonlinear propagation for efficient optical learning machines.” Advanced Photonics 6.1 (2024): 016002-016002.
[12] Luo, X uhao, et al. “M etasurface-enabled on-chip multiplexed diffractive neural networks in the visible.” Light: Science & Applications 11.1 (2022): 158.
[13] Qu, Geyang, et al. “All-dielectric metasurface empowered optical-electronic hybrid neural networks.” Laser & Photonics Reviews 16.10 (2022): 2100732.
[14] Zheng, Hanyu, et al. “Meta-optic accelerators for object classifiers.” Science Advances 8.30 (2022): eabo6410.
Zheng, Hanyu, et al. “Multichannel meta-imagers for accelerating machine vision.” Nature nanotechnology 19.4 (2024): 471-478.

We claim:

1. An optical neural networks (ONNs) system, comprising:
an optical metasurface comprising a plurality of arrays of sub-wavelength meta-atoms, wherein each meta-atom is independently configured to modulate both amplitude and phase of light beams incident to the optical metasurface for performing complex-valued dot products.

2. The ONNs system of claim 1, further comprising a focusing lens configured to receive and process light beams output from the optical metasurface.

3. The ONNs system of claim 1, wherein each meta-atom of the plurality of arrays of sub-wavelength meta-atoms is a sub-wavelength-scale pillar disposed on a two-dimensional plane.

4. The ONNs system of claim 3, wherein the pillar is made of silicon or TiO₂ on a SiO₂ substrate and has a cylindrical structure or a cubical structure.

5. The ONNs system of claim 4, wherein when the pillar has a cylindrical structure, the pillar has a diameter configured to finely tune its modulation coefficient.

6. The ONNs system of claim 4, wherein when the pillar has a cubical structure, in-plane angles of cuboid of the pillar are configured to finely tune its modulation coefficient.

7. The ONNs system of claim 1, wherein each meta-atom of the plurality of arrays of sub-wavelength meta-atoms is configured to act as an optical node for individually modulating a transmissive or reflective phase and amplitude of the input light beams.

8. The ONNs system of claim 7, wherein coefficients of the phase and amplitude modulation of each optical node are sampled from optimized Gaussian distribution.

9. The ONNs system of claim 2, wherein the optical metasurface and the focusing lens are configured to transform a raw optical image to a low-dimensional Fourier feature map.

10. The ONNs system of claim 9, wherein the raw optical image is element-wise modulated by the optical metasurface and then spatial components of the modulated optical image are weighted and linearly summed by spatial Fourier transformation performed by the focusing lens to generate the low-dimensional Fourier feature map.

11. The ONNs system of claim 9, wherein the raw optical image is element-wise modulated by the optical metasurface and then spatial components of the modulated optical image are weighted and linearly summed by spatial Fourier transformation performed by an optical focusing lens or another type of optical device.

12. The ONNs system of claim 11, wherein the other type of optical device includes diffractive gratings or optical diffusers.

13. The ONNs system of claim 1, wherein the performing complex-valued dot products is conducted with weights on a scale of millions to billions.

14. The ONNs system of claim 1, wherein geometry distribution of the plurality of arrays of sub-wavelength meta-atoms is configured such that corresponding matrix are ensured to attain an optimized Gaussian distribution.

15. A system for performing a machine vision task, comprising:
an optical metasurface comprising a plurality of arrays of sub-wavelength meta-atoms, wherein each meta-atom is independently configured to modulate both amplitude and phase of input light beams for performing complex-valued dot products;
a focusing lens configured to receive and process light beams output from the optical metasurface to generate a low-dimensional feature map;
an image sensor array configured to capture the low-dimensional feature map output from the focusing lens and convert the low-dimensional feature map into a feature map of a digital format; and
a digital processor configured to process the feature map of a digital format for performing the machine vision task.

16. The system of claim 15, wherein the low-dimensional feature map is down-sampled into the feature map of a digital format with adjustable pixel scales, depending on the machine vision task.

17. The system of claim 15, wherein the image sensor array is configured to perform an optoelectronic nonlinear activation method through square-law detection.

18. The system of claim 15, wherein the digital processor is configured to be trained by a highly compact neural network to generate a final decision for the machine vision task.

19. The system of claim 18, wherein the machine vision task is object classification, object detection, or video recognition.
